(19) United States
(12) Patent Application Publication
(10) Pub. No.: US 2008/0284053 A1
(43) Pub. Date: Nov. 20, 2008

(54) PROCESS AND MOLD FOR CREATING A SKIN SUPPLIED WITH AT LEAST ONE ITEM

(76) Inventor: Denis Dutouquet, Thumeries (FR)

Correspondence Address: FRASER CLEMENS MARTIN & MILLER LLC, 28366 KENSINGTON LANE, PERRYSBURG, OH, 43551, US

(21) Appl. No.: 12/108,941

(22) Filed: Apr. 24, 2008

(30) Foreign Application Priority Data
May 16, 2007 (FR) 07 55094

(51) Int. Cl. B29C 47/76

(52) U.S. Cl. 264/102

(57) ABSTRACT

A method of forming a covering for a motor vehicle interior is disclosed, wherein a skin is disposed in a mold between a male part and a female part having an item disposed thereon and a vacuum is created in the mold to form the skin against the item.

### CROSS-REFERENCE TO RELATED APPLICATION

This application claims the benefit of French Patent Application No. 0755094 filed May 16, 2007, hereby incorporated herein by reference in its entirety.

### FIELD OF THE INVENTION

This invention refers to the field for the creation of structural and/or decorative pieces made of plastic. Specifically, it concerns a process for creating a skin or a covering element provided with at least one item which cooperates with said skin or said covering element in order to render a virtually seamless visible surface therebetween.

### BACKGROUND OF THE INVENTION

The outfitting of a vehicle compartment, such as an entire instrument panel, is often made of components with a skin covering that can be seen by the occupant of the vehicle. Preferably, the exposed surface, commonly called the visible surface, is designed to have an aesthetically pleasing appearance.

The known processes do not allow for creating skins in which a transitional area between the built-in items and the visible surface of the skin is seamless, thus allowing a buildup of impurities under the visible surface and giving the visible surface an unsatisfying aesthetic appearance. Also, molds used to create such a skin are usually made of porous nickel and are produced by a very slow process, taking twenty-five or thirty weeks to produce, and the life expectancy of the molds is limited to around 400,000 production cycles.

It would be desirable to produce a skin to cover a foam part used to make a structural piece, in particular, a structural and/or decorative piece to be mounted on the inside of a motor vehicle and having a transitional area between the skin and the item with a seamless appearance.

### SUMMARY OF THE INVENTION

In accordance and agreement with the present invention, a process for producing a skin in which the transitional area between a built-in item and a visible surface of the skin is seamless, has surprisingly been discovered.

In one embodiment of the invention, the process comprises the steps of:
1. Placing at least one item on the functional embossed surface of the female part of a mold,
2. Aligning the surface of a preheated skin to the functional surface of the female part of said mold,
3. Closing the mold in an airtight manner,
4. Blowing the air out of the male part against the female part in order to imprint the grain of the functional surface of the female part against the skin and applying a vacuum force on the functional surface of the female part to flatten the skin against said functional surface and the non-visible part of each item and removing the air between the skin and the functional surface.

The invention also concerns a mold to create a skin supplied with at least one item by implementing the process according to the invention, constituted by one female part and one male part, characterized in that the female part is suitable for applying a vacuum force to the functional surface which will be placed in contact with the skin and the visible surface of each item and for removing the vacuumed air, in that the functional surface of the female part is embossed, in that the male part is suitable for blowing air in the direction of the female part, and in that the mold is suitable for being closed in an airtight manner.

### BRIEF DESCRIPTION OF THE DRAWINGS

The invention will be better understood, due to the description below, relative to a first embodiment, given as a non-restrictive example, and explained with reference to the attached schematic drawings, in which:

FIG. 1 is a side elevational view of a mold having a male part and a female part with an item disposed thereon accordingly to an embodiment of the invention;

FIG. 2 is a side elevational view of the mold of FIG. 1 with a skin disposed between the male part and the female part;

FIG. 3 is a side elevational view of the mold of FIG. 1 with the skin vacuum formed on the male part;

FIG. 4 is an enlarged side elevational view of the male part and the female part of FIG. 1 with the skin disposed therebetween and adjacent the item; and

FIG. 5 is a side elevational view of the skin formed over the item in the mold of FIG. 1.

### DETAILED DESCRIPTION OF THE EMBODIMENTS

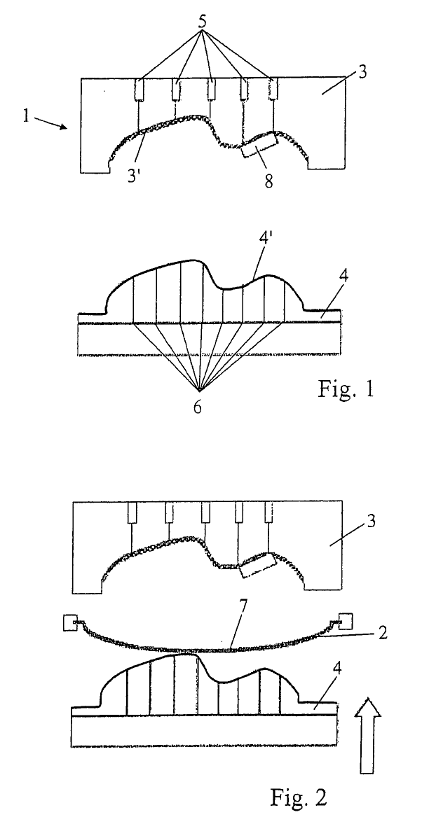

FIGS. 1 and 2 show a mold (1) for creating a skin (2) including a female part (3) and a male part (4) according to an embodiment of the invention. The mold (1) is adapted to be closed in an airtight manner.

The female part (3) is adapted to apply a vacuum force to a functional surface (3′). Further, the functional surface (3′) of the female part (3) is embossed. The embossed functional surface (3′) of the female part (3) of the mold (1) is intended to be in contact with a visible surface (7) of the skin (2) to be created. The embossed functional surface (3′) makes it possible to give the visible surface (7) a textured appearance. The embossed functional surface (3′) of the female part (3) of the mold (1) makes it possible thusly to create the last thermo-shaping of the skin (2) and to ensure the impression of a grain on the skin (2). In this way, a skin (2) made of synthetic material may have the appearance of leather. The functional surface (3′) of the female part (3) may be embossed by inserting the female part (3) in an acid solution or by a laser treatment of the functional surface (3′). Naturally, it is also possible to create the female part (3) of the mold (1) by reproducing the imprint of an embossed surface from a master pattern, for example by depositing a material on the embossed surface of the master pattern.

As shown in FIGS. 1 and 2, the female part (3) is supplied with vent holes (5) to facilitate the evacuation of air from the mold (1) with an air evacuation means. These vent holes also assure the aspiration of the skin (2) and its support on the functional surface (3′) of the female part (3) in such a way that it is shaped according to the contours of that functional surface (3′). Also, it is understood that the skin (2) may be pre-heated before it is inserted in the mold (1), thereby shaping the skin (2) and facilitating the process as described herein. The vent holes (5) may be formed by drilling crosswise passage ways in the female part (3). The passage ways or vent holes (5) may be formed in the material making up the female part (3) in a random fashion. If the vent holes (5) have a diameter greater than 0.2 millimeters, the vent holes (5) will form an imprint on the visible surface (7) of the skin (2), creating visible defects. It is therefore preferable to form the vent holes (5) outside the embossed functional surface (3′) of the female part (3) of the mold (1) to facilitate the formation of vent holes (5) having a diameter greater than 0.2 millimeters.

In the event where the female mold (3) is supplied with vent holes (5), the female mold (3) may be formed from a material chosen from a list consisting of steel, aluminum, nickel, and synthetic resins or a mixture of these materials. Alternatively, the female mold (3) may be formed from a porous material, such as porous nickel, synthetic resins, a mixture of these two materials, or a mixture of synthetic resins and aluminum, for example. The vent holes (5) or the porosity of the female part (3) of the mold (1) facilitate the evacuation of air from between the skin (2) and the functional embossed surface (3′) of the female part (3) in such a way to facilitate the printing of the functional embossed surface (3′) on the skin (2) and the shaping of the skin (2).

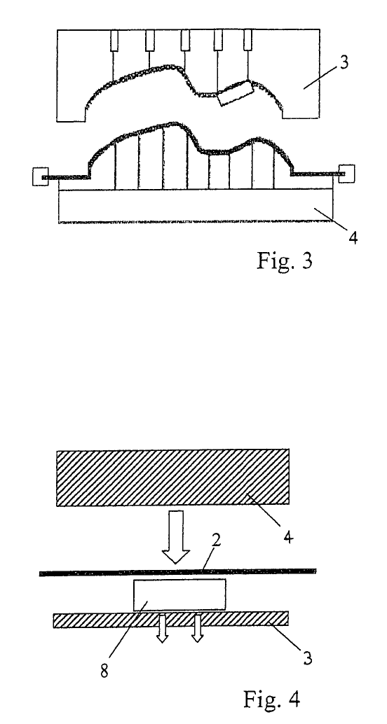

The male part (4) is adapted for blowing air in the direction of the female part (3). The act of blowing air in the direction of the female part (3) makes it possible to flatten the skin (2) to shape it against the female part (3), and also around the items (8) placed against the embossed functional surface (3′) of the female part (3). Vent holes (6) in fluid communication with an air blowing device may be formed in the male mold (6) to facilitate the vacuuming of air from the mold (1) or for blowing air in the direction of the female part (3) so as to flatten the skin (2) to shape it against the female part (3). Additionally, as shown in FIG. 3, the male part (4) may be adapted to vacuum the air from the mold (1) for pre-shaping the skin (2) prior to blowing air against the skin (2) in the direction of the female part (3).

The vent holes (6) may be formed by similar processes used to make the vent holes (5) in the female part (3) of the mold (1), as described herein. Alternatively, the male part (4) may be porous, in such a way that it is not necessary to form vent holes (6) therein, the air from the air blowing device being able to pass through the male part (4) due to its porosity. As with the female part (3), the male part (4) of the mold (1) may be made of steel, aluminum, a synthetic resin, or a mixture of these materials, for example.

The invention proposes therefore, an alternative to the porous nickel mold (1) to create a skin (2). The mold (1) according to the invention may be manufactured in this way within fifteen to eighteen weeks, while a corresponding mold (1) would need 25 or 35 weeks for manufacture. Also, the mold (1) according to this invention has a life expectancy much longer than that of the known porous nickel molds, and makes it therefore possible to carry out more production cycles than the latter.

According to an embodiment of the invention, a process for creating a skin (2) provided with at least one item (8) on its visible surface (7) comprises the steps of:

1. Placing at least one item (8) on the functional embossed surface (3′) of the female (3) part of a mold (1);

2. Aligning the surface of a preheated skin (2) to the functional surface (3′) of the female part (3) of the mold (1);

3. Closing the mold (1) in an airtight manner; and

4. Blowing the air out of the male part (4) against the female part (3) in order to imprint the grain of the functional surface (3′) of the female part (3) against the skin (2) and applying a vacuum force on the functional surface (3′) of the female part (3) to flatten the skin against the functional surface (3′) and the non-visible part of each item (8) and removing the air between the skin (2) and the functional surface (3′).

Each item (8) disposed in the mold (1) may be positioned in a different way. For example, the item (8) may be vacuumed by the female part (3) of the mold (1), or the item (8) may be glued to the female part (3). It may also be kept in position via a magnetic force. This process, associated with the mold (1), facilitates the incorporation of multiple items (8) of different sizes and shapes without needing a mold adapted to the size or shape of these items (8). Also, the mold (1) may be used to create a skin (2) that does or does not have one or more built-in items (8).

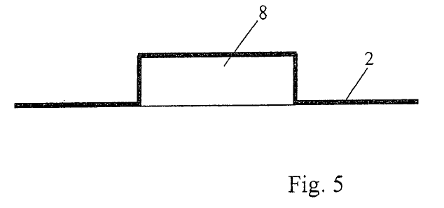

Moreover, the skin (2) is vacuumed by the female part (3), and simultaneously the skin (2) is blown by the male part (4) of the mold (1), as shown in FIG. 4. The skin (2) envelops the item(s) (8) positioned on the female part (3) of the mold, in such a way that a transitional area between the visible surface (7) of the skin (2) and the item (8) is seamless, as shown in FIG. 5.

As shown in FIG. 3, the process may also include a step of placing the male part (4) of the mold (1) under the female part (3) of the mold (1) and performing the following stages before the closure of the mold (1) in stage ii):
1. Preheat the skin (2); and
2. Place the skin (2) between the male part (4) and the female part (3) of the mold (1) and move the male part (4) towards the skin (2) by vacuuming the air from the male part (4) so that the skin (2) will shape itself over the functional surface (4′) of the male part (4).

Under these conditions, pre-shaping of the skin (2) is carried out on the male part (4) of the mold (1) that vacuums the skin (2) while moving towards the female part (3). This makes it possible to prepare the skin (2) for its final implementation by the female part (3) of the mold (1) while limiting the loss of temperature of the skin (2) since the male part (4) of the mold (1) may be temperature regulated.

Due to the mold (1) produced according to the invention and due to the manufacturing process for a skin (2) in this mold (1), it is then possible to make an embossed skin (2) supplied with one or more built-ins or items (8) on its visible surface with a seamless transitional area therebetween. Advantageously, this mold (1) may be used to create a skin (2) supplied with items (8) of any shape and positioned at any place.

The invention is not limited to the embodiments described and shown in the attached drawings. Modifications remain possible, in particular from the point of view of the make up of the various items or by substituting technical equivalents, without completely departing from the field of invention protection.

What is claimed is:

1. A method of forming a covering for a motor vehicle interior comprising the steps of:
providing a mold having a male part having a plurality of vent holes formed therein and a female part having a plurality of vent holes formed therein and having a functional surface;
disposing an item on at least a portion of the functional surface of the female part;
positioning a skin between the male part and the female part of the mold;
closing the mold to provide an airtight seal therein;
introducing air through the vent holes of the male part and against the skin; and
evacuating air from the mold through the vent holes of the female part to create a vacuum in the mold to form the skin over the item and against the female part.

2. The method of claim 1, further comprising the step of heating the skin prior to positioning the skin in the mold.

3. The method of claim 1, wherein the vent holes of the male part are in fluid communication with an air blowing device.

4. The method of claim 1, wherein the vent holes of the male part are in fluid communication with an air evacuation device.

5. The method of claim 4, further comprising the step of evacuating air from the mold to form the skin over the male part to facilitate a pre-shaping of the skin.

6. The method of claim 1, wherein at least one of the male part and the female part is formed from a porous material.

7. The method of claim 1, wherein the male part and the female part are formed from at least one of nickel, steel, aluminum, and synthetic resin.

8. The method of claim 1, wherein the functional surface of the female part is embossed.

9. The method of claim 1, wherein the item is disposed on the functional surface of the female part with one of an adhesive and a magnet.

10. The method of claim 1, wherein the vent holes of the female part are in fluid communication with an air evacuation means.

11. The method of claim 10, wherein the vacuum in the mold is created by evacuating the air from the mold through the vent holes of the female part with the air evacuation means.

12. The method of claim 10, wherein the vent holes are formed in the functional surface of the female part.

13. The method of claim 10, wherein the vent holes are formed in a surface outside of the functional surface of the female part.

14. A method of forming a covering for a motor vehicle interior comprising the steps of:
providing a mold having a male part having a plurality of vent holes formed therein and a female part having a plurality of vent holes formed therein and having a functional surface;
disposing an item on at least a portion of the functional surface of the female part;
positioning a skin between the male part and the female part of the mold;
evacuating air from the mold through the vent holes of the male part to form the skin over the male part to facilitate a pre-shaping thereof;
closing the mold to provide an airtight seal therein;
introducing air through the vent holes of the male part and against the skin; and
evacuating air from the mold through the vent holes of the female part to create a vacuum in the mold to form the skin over the item and against the female part, wherein a transitional area between the item and the skin is substantially seamless.

15. The method of claim 14, further comprising the step of heating the skin prior to positioning the skin in the mold.

16. The method of claim 14, wherein at least one of the male part and the female part is formed from a porous material.

17. The method of claim 14, wherein the functional surface of the female part is embossed.

18. The method of claim 14, wherein the item is disposed on the functional surface of the female part with one of an adhesive and a magnet.

19. A method of forming a covering for a motor vehicle interior comprising the steps of:
providing a mold having a male part having a plurality of vent holes formed therein and a female part having a plurality of vent holes formed therein and having a functional surface;
disposing an item on at least a portion of the functional surface of the female part;
heating a skin;
positioning the heated skin between the male part and the female part of the mold;
closing the mold to provide an airtight seal therein;
introducing air through the vent holes of the male part and against the skin; and
evacuating air from the mold through the vent holes of the female part to create a vacuum in the mold to form the skin over the item and against the female part.

20. The method of claim 10, wherein the functional surface of the female part is embossed.
